(19) United States
(12) Patent Application Publication
(10) Pub. No.: US 2024/0336119 A1
(43) Pub. Date: Oct. 10, 2024

(54) VEHICLE DOOR COVER SYSTEM

(71) Applicant: MANUEL MARTINEZ, Miami, FL (US)

(72) Inventor: MANUEL MARTINEZ, Miami, FL (US)

(21) Appl. No.: 18/296,463

(22) Filed: Apr. 6, 2023

(51) Int. Cl. B60J 11/06

(52) U.S. Cl. CPC B60J 11/06

(57) ABSTRACT

A vehicle door cover system that is used to cover an inner part of a side door of a vehicle when a side window of the vehicle is tinted. The vehicle door cover system comprises of a guide and a plastic cover. A lower part of the guide is inserted into a slit that is between the side window of the vehicle and an inner upper part of a side door of the vehicle. The plastic cover is removably attached to guide after the lower part of the guide is within the slit of the window. The plastic cover covers the controls and the inner part of the side door of the vehicle.

### BACKGROUND

The present invention is directed to a vehicle door cover system that is used to cover the inner part of a side door when a side window of a vehicle is being tinted.

When a window tint is installed on a side window of a vehicle, copious liquid is sprayed over the window tint. The liquid tends to drench the inner part of the side door and the controls of the side door. When this happens, water damage occurs to the vehicle's inner part of the side door and the controls of the side door.

The water damage that occurs to the vehicle's inner part of the side door and the controls of the side door sometimes require replacement of the inner side or the controls of the side door.

The vehicle door cover system of the present invention minimizes the occurrence of the above water damage.

For the foregoing reasons, there is a need for a vehicle door cover system that prevents water damage to the inner part of the side door and the controls on the side door of a vehicle when a side window is tinted.

### SUMMARY

A vehicle door cover system that is used to cover an inner part of a side door of a vehicle when a side window of the vehicle is tinted. The vehicle door cover system comprises of a guide and a plastic cover. A lower part of the guide is inserted into a slit that is between the side window of the vehicle and an inner upper part of a side door of the vehicle. The plastic cover is removably attached to guide after the lower part of the guide is within the slit of the window. The plastic cover covers the controls and the inner part of the side door of the vehicle.

The guide of the vehicle door cover system is made of a rigid material. The guide has a length that is at least sixteen inches in length. The guide has a lower part that is inserted within the slit, a middle part that has a first hook and loop attachment that is configured to attach to a second hook and loop attachment, and upper part that is configured to serve as a handle.

The plastic cover is made of a soft plastic material. The plastic cover has a second hook and loop attachment that runs along the length of an upper part of the plastic cover. The second hook and loop attachment attaches to the first hook and loop attachment and the plastic cover drapes over the upper part of the guide.

An object of the present invention is to prevent the electrical components of a side door from being water damaged when a window of the side door is being tinted.

Another object of the present invention is to prevent a side door from being water damaged when a window of the side door is being tinted.

### BRIEF DESCRIPTION OF THE DRAWINGS

These and other features, aspects, and advantages of the present invention will become better understood with regards to the following description, appended claims, and drawings where:

FIG. 1 is a perspective view of the system of the present invention;

FIG. 2 is a perspective view of the guide of the present invention;

FIG. 3 is a front side view of the plastic cover of the present invention;

FIG. 4 is a perspective view of the present invention that has a magnified view that that shows how the hook and loop materials attach to each other;

FIG. 5 is a side view of the present invention that has two exploded views that shows how the guide is inserted within the slit of a side vehicle door; and

FIG. 6 a side view that shows how the present invention is mounted on a door.

### DESCRIPTION

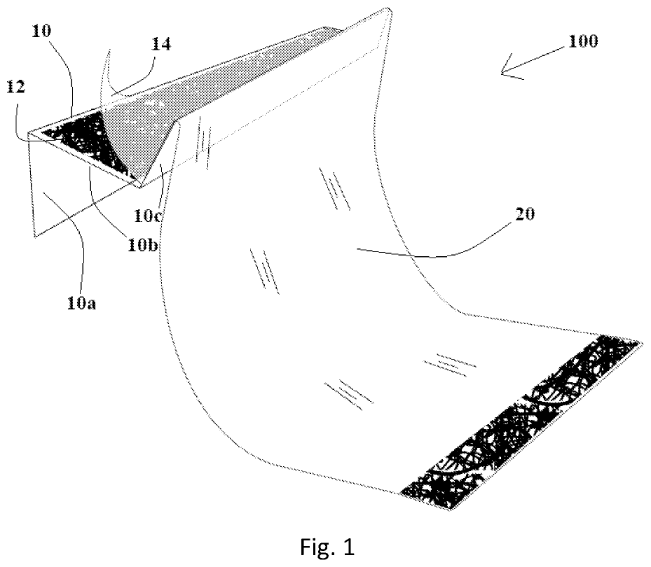

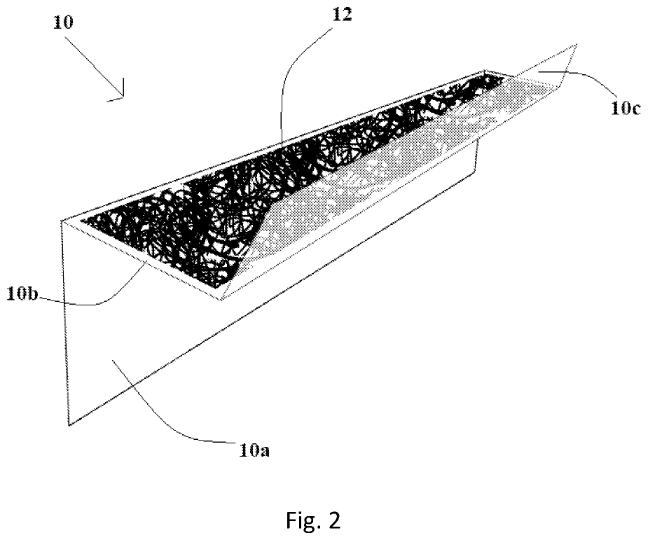

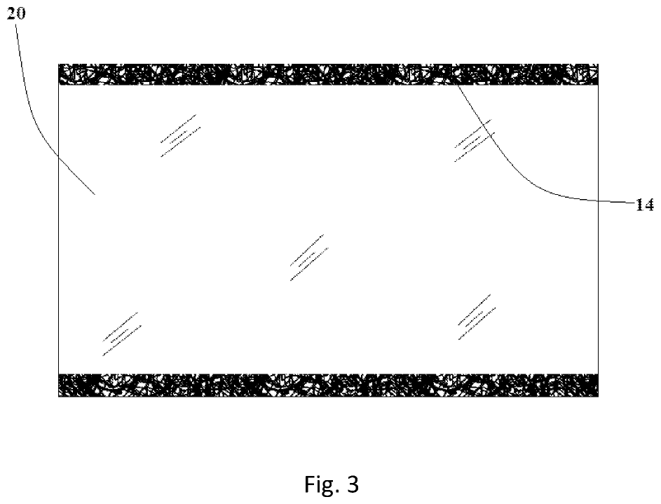

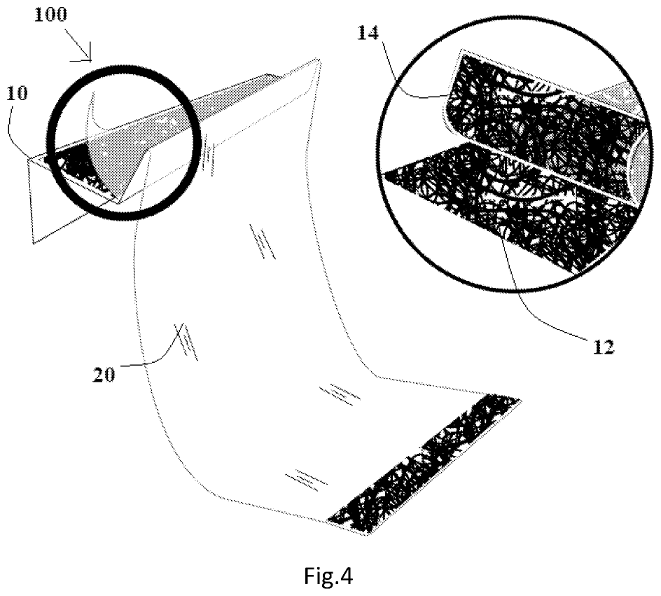

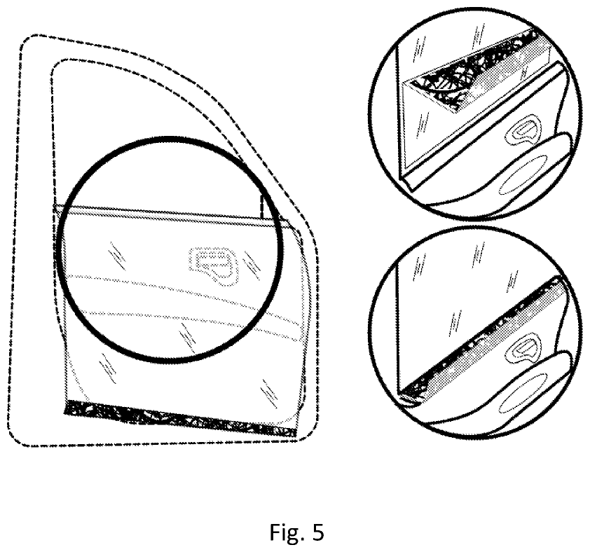

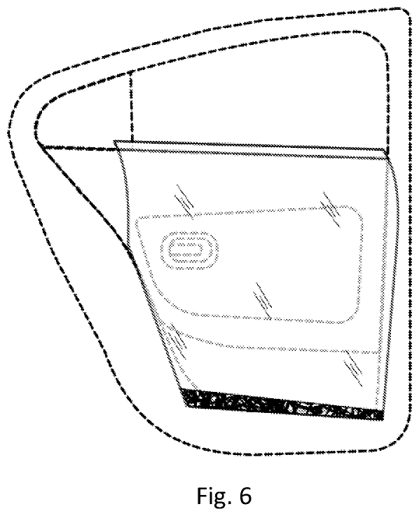

As seen in FIGS. 1-6, the present invention is a vehicle door cover system 100 that is used to cover an inner part of a side door of a vehicle when a side window of the vehicle is tinted. The vehicle door cover system 100 comprises of a guide 10 that is configured to be inserted into a slit that is between the side window of the vehicle and an inner upper part of a side door of the vehicle. The guide 10 is made of a rigid material that has a length that is at least sixteen inches in length. The guide 10 has a lower part 10a that measures at least three inches in width, a middle part 10b that is at least two inches in width that is perpendicular to the lower part 10a, and an upper part 10c that is at least one inch in width that is perpendicular to the middle part 10b and that extends outwards from the lower part 10a. A first hook and loop attachment 12 is adhered to the middle part 10b of the guide 10 and the first hook and loop attachment 12 runs along the length of the middle part 10b of the guide 10. The lower part of the guide 10a is configured to be inserted within the slit. The middle part 10b of the guide 10 is configured to receive a second hook and loop attachment 14 of a plastic cover 20. The upper part 10c is configured to be a handle that is pulled inward from the side door when adjusting the vehicle door cover system 100 that is used to cover the side door. And, the plastic cover 20. The plastic cover 20 is a rectangular strip 20 of material that has an upper side 20a that has a length that is at least sixteen inches. The upper side 20a has the second hook and loop attachment 14 that is adhered to the upper side 20a of the rectangular strip 20 along its length. The rectangular strip 20 has a width of at least twenty-four inches. The second hook and loop attachment 14 is adhered to the first hook and loop attachment 12 so that the plastic cover 20 drapes over the upper part 10c of the guide 10. The plastic cover 20 is configured to cover the inner part of the side door when the side window is being tinted.

In an embodiment of the present invention, the guide 10 has a length that is twenty inches and the rectangular strip 20 has a length that is twenty inches.

In another embodiment of the present invention, the guide 10 has a length that is twenty-six inches and the rectangular strip has a length that is twenty-six inches.

In still another embodiment of the present invention, the rectangular strip 20 is made of an ethylene vinyl acetate material.

In yet still another embodiment of the present invention, the guide is made of a hard plastic.

In a further embodiment of the present invention, the guide is made of an aluminum.

An advantage of the present invention is that it prevents the electrical components of a side door from being water damaged when a window of the side door is tinted.

Another advantage of the present invention is that it prevents an inner part of a side door from being water damaged when a window of the side door is tinted.

The embodiments of the vehicle door cover system that is used to cover an inner part of a side door of a vehicle described herein are exemplary and numerous modifications, combinations, variations, and rearrangements can be readily envisioned to achieve an equivalent result, all of which are intended to be embraced within the scope of the appended claims. Further, nothing in the above-provided discussions of the vehicle door cover system that is used to cover an inner part of a side door of a vehicle should be construed as limiting the invention to an embodiment or a combination of embodiments. The scope of the invention is defined by the description, drawings, and appended claims.

What is claimed is:

1. A vehicle door cover system that is used to cover an inner part of a side door of a vehicle when a side window of the vehicle is tinted, the vehicle door cover system comprises of:
a guide that is configured to be inserted into a slit that is between the side window of the vehicle and an inner upper part of a side door of the vehicle, the guide is made of a rigid material that has a length that is at least sixteen inches in length, the guide has a lower part that measures at least three inches in width, a middle part that is at least two inches in width that is perpendicular to the lower part, and an upper part that is at least one inch in width that is perpendicular to the middle part and that extends outwards from the lower part, a first hook and loop attachment is adhered to the middle part of the guide and the hook and loop attachment runs along the length of the middle part of the guide, the lower part of the guide is configured to be inserted within the slit, the middle part of the guide is configured to receive a second hook and loop attachment of a plastic cover, the upper part is configured to be a handle that is pulled inward from the side door when adjusting the vehicle door cover system that is used to cover the side door; and
the plastic cover, the plastic cover is a rectangular strip of material that has an upper side that has a length that is at least sixteen inches, the upper side has the second hook and loop attachment that is adhered to the upper side of the rectangular strip along its length, the rectangular strip has a width of at least twenty-four inches, the second hook and loop attachment is adhered to the first hook and loop attachment so that the plastic cover drapes over the upper part of the guide, the plastic cover is configured to cover the inner part of the side door when the side window is being tinted.

2. The vehicle door cover system that is used to cover the inner part of the side door of the vehicle when the side window of the vehicle is tinted of claim 1, wherein the guide has a length that is twenty inches, and the rectangular strip has a length that is twenty inches.

3. The vehicle door cover system that is used to cover the inner part of the side door of the vehicle when the side window of the vehicle is tinted of claim 1, wherein the guide has a length that is twenty-six inches, and the rectangular strip has a length that is twenty-six inches.

4. The vehicle door cover system that is used to cover the inner part of the side door of the vehicle when the side window of the vehicle is tinted of claim 1, wherein the rectangular strip is made of an ethylene vinyl acetate material.

5. The vehicle door cover system that is used to cover the inner part of the side door of the vehicle when the side window of the vehicle is tinted of claim 1, wherein the guide is made of a hard plastic.

6. The vehicle door cover system that is used to cover the inner part of the side door of the vehicle when the side window of the vehicle is tinted of claim 1, wherein the guide is made of aluminum.
